(19) United States
(12) Patent Application Publication
(10) Pub. No.: US 2011/0019451 A1
(43) Pub. Date: Jan. 27, 2011

(54) Power Supply Auxiliary Circuit

(76) Inventor: Ti-Hua Ko, Taipei (TW)

Correspondence Address: Lin & Associates;Intellectual Property, Inc., PO Box 2339, Saratoga, CA, 95070-0339, US

(21) Appl. No.: 12/509,446

(22) Filed: Jul. 25, 2009

(51) Int. Cl. H02M 7/06

(52) U.S. Cl. 363/126

(57) ABSTRACT

A power supply auxiliary circuit includes a power input unit for receiving an AC input voltage, a voltage regulating unit for dropping the AC input voltage, a rectifying unit for converting the dropped AC input voltage into a DC voltage, a snubber unit for filtering the DC voltage, a power output unit for sending the filtered DC voltage, a switch unit connected between the rectifying unit and a feedback control unit, and the feedback control unit connected between the power output unit and the switch unit for detecting and analyzing the output voltage of the power output unit, and then generating a corresponding control signal to determine a switch state of the switch unit that makes the current from the rectifying unit partially back-flow to the power input unit or not, and further regulates the value of the output voltage of the power output unit.

### BACKGROUND OF THE INVENTION

1. Field of the Invention

The present invention generally relates to a power supply circuit, and more particularly to a power supply auxiliary circuit.

2. The Related Art

Referring to FIG. 2, a conventional power supply auxiliary circuit includes a power input unit 10, a power output unit 11, two step-down capacitors C1, C3 and a second diode D2 series-connected between the two step-down capacitors C1, C3. The power input unit 10 is drawn forth from another two terminals of the two step-down capacitors C1, C3. The power supply auxiliary circuit further includes a first diode D1 and a snubber capacitor C2 series-connected with each other and then parallel-connected to the second diode D2, wherein the first diode D1 is reverse with the second diode D2. The power output unit 11 is drawn forth from two terminals of the snubber capacitor C2 and adapted for connecting external circuits (not shown) to supply required power thereto. An input voltage from the power input unit 10 is firstly dropped by the step-down capacitors C1, C3, then rectified by the diodes D1, D2, and lastly filtered by the snubber capacitor C2 so that a required output voltage is output by the power output unit 11. However, the foregoing power supply auxiliary circuit has no voltage regulator. As a result, the output voltage is inconstant.

Referring to FIG. 3 and FIG. 4, another two power supply auxiliary circuits are shown to overcome the foregoing problem, wherein the two power supply auxiliary circuits respectively utilize a zener diode D3, D5 to regulate the output voltage thereof so as to output a relatively constant voltage for the external circuits. However, when the external circuits are unexpectedly disconnected from the power supply auxiliary circuit, a high-powered current is unavoidable to generate on the zener diode D3, D5 so that may shorten their usable life. Therefore, a power supply auxiliary circuit capable of overcoming all the above-mentioned problems is required.

### SUMMARY OF THE INVENTION

An object of the present invention is to provide a power supply auxiliary circuit which includes a power input unit for receiving an AC input voltage from an external power supply, a voltage regulating unit for dropping the AC input voltage from the power input unit, a rectifying unit for converting the dropped AC input voltage by the voltage regulating unit into a DC voltage, a snubber unit for filtering the DC voltage into a proper DC output voltage, a power output unit for supplying the proper DC output voltage filtered by the snubber unit to an external circuit, a switch unit connected between the rectifying unit and a feedback control unit, and the feedback control unit connected between the power output unit, and the switch unit for detecting and analyzing the output voltage of the power output unit and then generating a corresponding control signal so as to determine a switch state of the switch unit that makes the current from the rectifying unit partially back-flow to the power input unit or not, and further regulates the value of the output voltage of the power output unit. Therefore, the power supply auxiliary circuit of the present invention can always supply a relatively constant DC output voltage to the external circuit. Furthermore, even if the external circuit is unexpectedly disconnected from the power output unit, a high-powered current can be avoided to generate thereby so that the power supply auxiliary circuit has a relatively longer usable life.

### BRIEF DESCRIPTION OF THE DRAWINGS

The present invention will be apparent to those skilled in the art by reading the following description, with reference to the attached drawings, in which:

FIG. 1 is a circuitry of a power supply auxiliary circuit according to the present invention; and

FIGS. 2-4 are respectively a circuitry of a conventional power supply auxiliary circuit.

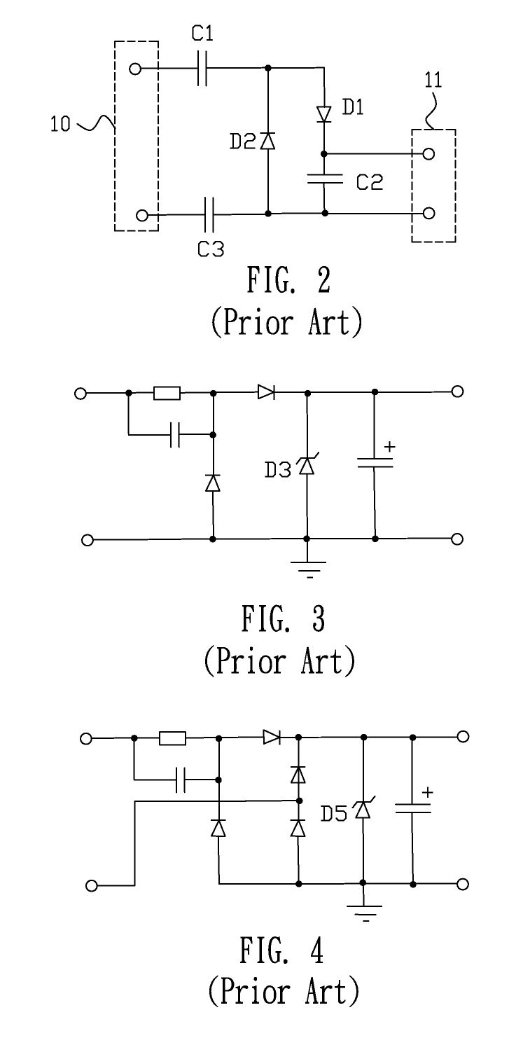

### DETAILED DESCRIPTION OF THE PREFERRED EMBODIMENT

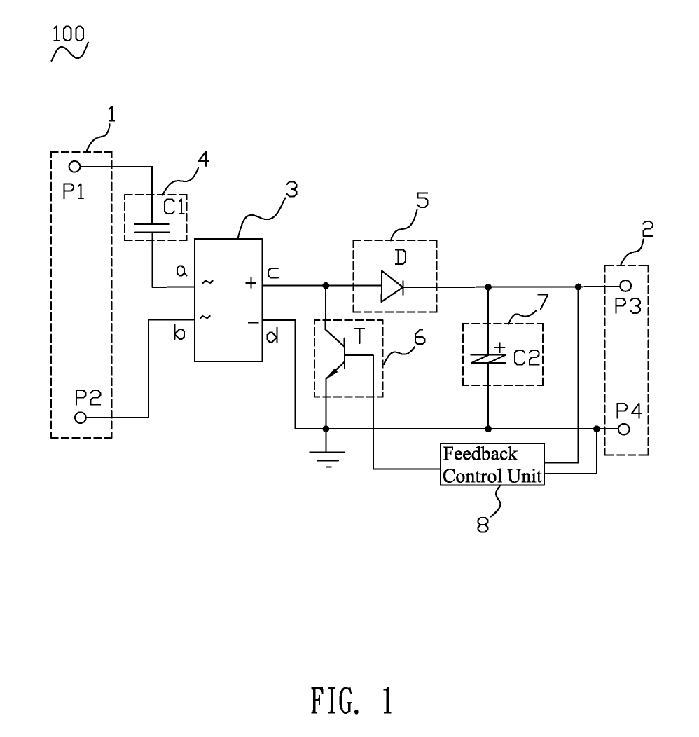

With reference to FIG. 1, a power supply auxiliary circuit 100 of the prevent invention includes a power input unit 1, a power output unit 2, a rectifying unit 3, a voltage regulating unit 4, an unidirectional unit 5, a switch unit 6, a snubber unit 7 and a feedback control unit 8.

The power input unit 1 includes a live input terminal P1 and a neutral input terminal P2 and is adapted for connecting an external AC power supply (not shown) to get an AC input voltage. The power output unit 2 includes a positive output terminal P3 and a negative output terminal P4 and is adapted for connecting an external circuit (not shown) to supply a required DC output voltage thereto.

The rectifying unit 3 may be either a full-wave rectifier or a half-wave rectifier and is adapted for converting AC into DC. The rectifying unit 3 has a first connecting terminal a, a second connecting terminal b, a positive connecting terminal c and a negative connecting terminal d. The voltage regulating unit 4 is series-connected between the first connecting terminal a of the rectifying unit 3 and the live input terminal P1 for dropping the AC input voltage of the power input unit 1 and then transmitting the dropped AC input voltage into the rectifying unit 3. In this embodiment, the voltage regulating unit 4 is a step-down capacitor C1. The second connecting terminal b is connected with the neutral input terminal P2. The positive connecting terminal c is connected to the positive output terminal P3 through the unidirectional unit 5, wherein the unidirectional unit 5 can allow current to flow in a forward direction and block current in a reverse direction as long as the voltage thereon does not exceed a predetermined threshold. In the embodiment, the unidirectional unit 5 is a diode D having the anode connected with the positive connecting terminal c of the rectifying unit 3 and the cathode connected with the positive output terminal P3. The negative connecting terminal d of the rectifying unit 3 is connected with the negative output terminal P4. The snubber unit 7 is an electrolytic capacitor C2 in the embodiment. One terminal of the snubber unit 7 is connected between the unidirectional unit 5 and the positive output terminal P3, and the other terminal thereof is connected between the negative connecting terminal d of the rectifying unit 3 and the negative output terminal P4. After the dropped AC input voltage is converted into a DC voltage by the rectifying unit 3, the DC voltage is further filtered by the snubber unit 7 and then is output by the power output unit 2.

The switch unit 6 is a transistor T in the embodiment having the collector connected with the positive connecting terminal c of the rectifying unit 3, and the emitter connected with the negative connecting terminal d of the rectifying unit 3 and further connected to ground. The feedback control unit 8 is connected between the power output unit 2 and the base of the switch unit 6, wherein both the positive output terminal P3 and the negative output terminal P4 of the power output unit 2 are connected with the feedback control unit 8. The feedback control unit 8 detects the output voltage of the power output unit 2 and then compares the output voltage with a reference voltage predetermined therein so as to transmit a corresponding control signal according to the compared result to determine a switch state of the switch unit 6.

If the output voltage is higher than the reference voltage, the switch unit 6 is controlled to be on by the feedback control unit 8 according to the control signal. As a result, the current from the positive connecting terminal c of the rectifying unit 3 is partially back-flowed to the neutral input terminal P2 by means of the switch unit 6, the negative connecting terminal d and the second connecting terminal b of the rectifying unit 3 so as to regulate the output voltage of the power output unit 2 until the output voltage of the power output unit 2 is not higher than the reference voltage any more. At this moment, the switch unit 6 is controlled to be off by the feedback control unit 8. So a relatively constant DC output voltage can be supplied by the power output unit 2 to the external circuit.

As described above, the power supply auxiliary circuit 100 utilizes the feedback control unit 8 to detect and analyze the output voltage of the power output unit 2, and then determine the switch state of the switch unit 6 so as to regulate the output voltage of the power output unit 2 instead of zener diodes of the prior art. Therefore, the power supply auxiliary circuit 100 of the present invention can always supply a relatively constant DC output voltage to the external circuit. Furthermore, even if the external circuit is unexpectedly disconnected from the power output unit 2, a high-powered current can be avoided to generate thereby so that the power supply auxiliary circuit 100 has a relatively longer usable life.

What is claimed is:

1. A power supply auxiliary circuit, comprising:
a power input unit for receiving an AC input voltage from an external power supply;
a voltage regulating unit for dropping the AC input voltage from the power input unit;
a rectifying unit for converting the dropped AC input voltage by the voltage regulating unit into a DC voltage;
a snubber unit for filtering the DC voltage into a proper DC output voltage;
a power output unit for supplying the proper DC output voltage filtered by the snubber unit to an external circuit;
a switch unit connected between the rectifying unit and a feedback control unit; and
the feedback control unit connected between the power output unit and the switch unit for detecting and analyzing the output voltage of the power output unit, and then generating a corresponding control signal so as to determine a switch state of the switch unit that makes the current from the rectifying unit partially back-flow to the power input unit or not, and further regulates the value of the output voltage of the power output unit.

2. The power supply auxiliary circuit as claimed in claim 1, wherein the feedback control unit analyzes the output voltage by means of comparing the output voltage with a reference voltage predetermined therein, the output voltage of the power output unit is regulated by means of the feedback control unit controlling the switch unit to be on to make the current from the rectifying unit partially back-flowed to the power input unit through the switch unit and the rectifying unit when the output voltage is higher than the reference voltage, and off when the output voltage is not higher than the reference voltage.

3. The power supply auxiliary circuit as claimed in claim 1, wherein the rectifying unit is either a full-wave rectifier or a half-wave rectifier and has a first connecting terminal, a second connecting terminal, a positive connecting terminal and a negative connecting terminal, the power input unit is connected with the first and second connecting terminals through the voltage regulating unit, the snubber unit is connected between the positive and negative connecting terminals.

4. The power supply auxiliary circuit as claimed in claim 3, wherein the voltage regulating unit is a step-down capacitor connected between the first connecting terminal of the rectifying unit and the power input unit.

5. The power supply auxiliary circuit as claimed in claim 4, wherein the switch unit is a transistor having the collector connected with the positive connecting terminal of the rectifying unit and the emitter connected with the negative connecting terminal of the rectifying unit, the feedback control unit is connected with the base of the transistor to control the transistor on to make the current from the positive connecting terminal of the rectifying unit partially back-flowed to the power input unit through the switch unit, the negative connecting terminal and the second connecting terminal of the rectifying unit, and off.

6. The power supply auxiliary circuit as claimed in claim 1, further comprising an unidirectional unit series-connected between the rectifying unit and the power output unit for blocking a reverse current.
